(19) United States
(12) Patent Application Publication
(10) Pub. No.: US 2001/0022338 A1
(43) Pub. Date: Sep. 20, 2001

(54) Probe signal outputting apparatus

(76) Inventors: Yoshiki Yanagisawa, Tokyo (JP); Nobukazu Banjo, Tokyo (JP); Jun Kikuchi, Tokyo (JP); Sanjay Gupta, Tokyo (JP); Mitsuru Shinagawa, Isehara-shi (JP); Chisato Hashimoto, Sagamihara-shi (JP); Tadao Nagatsuma, Sagamihara-shi (JP); Hakaru Kyuragi, Tokyo (JP)

Correspondence Address: Robert E. Krebs, Esq., BURNS, DOANE, SWECKER & MATHIS, L.L.P., P.O. Box 1404, Alexandria, VA, 22313-1404, US

(21) Appl. No.: 09/738,763

(22) Filed: Dec. 18, 2000

(30) Foreign Application Priority Data
Dec. 27, 1999 (JP) 11-371915

(51) Int. Cl. H01J 40/14

(52) U.S. Cl. 250/214 R

(57) ABSTRACT

Disclosed is a probe signal outputting apparatus comprising an electrooptic probe for receiving an optical output from a light source and outputting a first optical signal and a second optical signal which are polarized in accordance with a voltage of a to-be-probed signal from an object to-be-probed; a first photoelectric converting element and a second photoelectric converting element, connected in series between a first bias power supply and a second bias power suppl, for respectively receiving the first optical signal and the second optical signal and converting the first and second optical signals to electric signals; an output circuit for outputting an electric signal acquired at a connection node between the first photoelectric converting element and the second photoelectric converting element; a current drive circuit, provided in an optical input/output unit together with the first photoelectric converting element, the second photoelectric converting elements and the output circuit, for supplying a drive current to the light source upon reception of a control voltage according to changes in currents flowing in the first photoelectric converting element and the second photoelectric converting element; and a power-supply/probe-signal output unit connected to the optical input/output unit and having an amplifier for amplifying the electric signal acquired at the connection node and outputting that amplified electric signal to a probing circuit side and a power supply for supplying power into an electric circuit in the optical input/output unit, wherein the electrooptic probe and the optical input/output unit are connected by a cable and the optical input/output unit and the power-supply/probe-signal output unit are connected by a connector in a separable manner.

### BACKGROUND OF THE INVENTION

1. Field of the Invention

The present invention relates to a probe signal outputting apparatus which acquires, as a probe signal, an electric signal according to a to-be-probed signal, from an optical signal containing a polarization component according to the voltage of the to-be-probed signal and supplies the probe signal to a measuring unit.

This application is based on Japanese Patent Application No. Hei 11-371915 filed in Japan, the content of which is incorporated herein by reference.

2. Description of the Related Art

One conventional probe signal outputting apparatus comprises an electrooptic probe incorporating an optical system for coupling an electrooptic crystal whose polarization plane is changed by an electric field to a portion where an internal signal of a target object to-be-probed, such as an IC, (hereinafter called “to-be-probed signal”) appears, reproduces the to-be-probed signal according to the polarization state of reflected light from this electrooptic crystal and acquires an optical signal having a polarization state corresponding to the to-be-probed signal, and a light receiving circuit for receiving this optical signal and acquiring an electric signal according to the polarization state of the optical signal.

This probe signal outputting apparatus has the following advantages over a conventional measuring system using an electric probe.

1) Due to no ground line needed at the time of measuring a signal, measurement is easier.

2) As a metal pin at the distal end of the electrooptic probe is electrically insulated from circuits on an oscilloscope side, waveform observation is possible without nearly disturbing the status of a to-be-probed signal.

3) The use of an optical pulse ensures measurement in a wide band in the order of up to gigahertz.

An example of the structure of an electrooptic probe which is used in this probe signal outputting apparatus will be described with reference to FIG. 2. In this diagram, a metal pin 1a which contacts a portion where a to-be-probed signal appears is fitted in the center of a probe head 1 made of an insulator. An electrooptic element (electrooptic crystal) 2 whose polarization plane is changed by an electric field has a reflection film 2a provided on that end face which is located on the metal pin side. The reflection film 2a is in contact with the metal pin 1a.

Numeral “4” denotes a ½ wavelength plate and numeral “5” denotes a ¼ wavelength plate. Numerals “6” and “8” are polarization beam splitters. Numeral “7” denotes a Faraday cell. Numeral “9” denotes a laser diode which emits a laser beam in accordance with a pulse signal (control signal) 9 output from the main body of a measuring unit (not shown), such as an EOS (electro-optic sampling) oscilloscope. Numeral “10” denotes a collimator lens which converts the laser beam from the laser diode 9 to parallel beam L. The electrooptic element 2, the ½ wavelength plate 4, the ¼ wavelength plate 5, the polarization beam splitters 6 and 8 and the Faraday cell 7 are arranged on the optical path of a parallel laser beam L.

Numerals “11” and “13” denote converging lenses which respectively converge laser beams split by the polarization beam splitters 6 and 8. Numerals “12” and “14” denote photodiodes as photoelectric converting elements, which convert the laser beams converged by the conversing lenses 11 and 13 to electric signals and send the signals to the main body of the measuring unit. The photodiodes 12 and 14 constitute a light receiving circuit to be discussed below.

Numeral “15” is a probe body serving as an electrooptic probe. Numeral “17” denotes an isolator which comprises the ¼ wavelength plate 5, the two polarization beam splitters 6 and 8 and the Faraday cell 7. The isolator 17 passes light emitted from the laser diode 9 and separates light which is reflected at the reflection film 2a.

An example of the structure of the conventional light receiving circuit which is used in a probe signal outputting apparatus will now be described with reference to FIG. 3. In this diagram, numeral “100” is a bias power supply, numerals “12” and “14” are photodiodes, numerals “102” and “105” are resistors, numerals “103” and “106” are amplifiers, numeral “107” is a current monitor, numeral “108” is an A/D converter, numeral “109” is a differential amplifier which comprises resistors 109A to 109D and an operational amplifier 109E, numeral “110” is a resistor and numeral “111” is an A/D converter.

In this light receiving circuit, the amplifiers 103 and 106 respectively amplify currents, which are generated by the photodiodes 12 and 14 and are biased by the bias power supply 100, and the differential amplifier 109 amplifies the difference between the outputs of the amplifiers 103 and 106, thus yielding a probe signal. The output value of the differential amplifier 109 is subjected to A/D conversion in the A/D converter 111. The currents generated by the photodiodes 12 and 14 are monitored by the current monitor 107 and the current values are subjected to A/D conversion in the A/D converter 108.

The operation of this conventional apparatus will be discussed below. The laser diode 9 shown in FIG. 2 emits a pulsed laser beam having a sampling period when driven by a pulse signal (control signal). This laser beam is converted by the collimator lens 10 to parallel light which travels straight through the polarization beam splitter 8, the Faraday cell 7 and the polarization beam splitter 6, further passes through the ¼ wavelength plate 5 and the ½ wavelength plate 4 and enters the electrooptic element 2.

The incident laser beam is reflected by the reflection film 2a formed at the end face of the electrooptic element 2 that is located on the metal pin side. When the metal pin 1a is put in contact with a probing point, an electric field according to the voltage that is applied to the metal pin 1a propagates to the electrooptic element 2, causing the index of refraction of the electrooptic element 2 to change due to the Pockels effect. As the laser beam emitted from the laserdiode 9 propagates in the electrooptic element 2, the polarization state of the light changes, so that the laser beam reflected at the end face 2a of the electrooptic element 2 contains a polarized component according to the voltage of a to-be-probed signal.

The laser beam reflected at the end face 2a of the electrooptic element 2 passes through the ½ wavelength plate 4 and the ¼ wavelength plate 5 again, and a part of this laser beam (the polarized component according to the voltage of the to-be-probed signal) is separated by the polarization beam splitter 6 and is converged by the conversing lens 11 before entering the photodiode 12 that constitutes the light receiving circuit. The laser beam that has passed the polarization beam splitter 6 is separated by the polarization beam splitter 8 and is converged by the conversing lens 13. This converged light enters the photodiode 14 shown in FIG. 3 to be converted to an electric signal.

The operation of the light receiving circuit will now be discussed. When the index of refraction of the electrooptic element 2 changes due to a change in the voltage of the to-be-probed signal, the output of the photodiode 12 differs from the output of the photodiode 14. The light receiving circuit operates in such a way as to detect this output difference and output a probe signal according to the to-be-probed signal.

This will be described below specifically. When the photodiode 12 of the light receiving circuit receives the laser beam from the polarization beam splitter 6, the photodiode 12 produces the current according to the intensity of this laser beam. A voltage according to this current appears at one end of the resistor 102 and is amplified by the amplifier 103. The differential amplifier 109 sends a probe signal according to the difference between the outputs of the amplifiers 103 and 106 to the main body of the measuring unit.

According to the conventional light receiving circuit, as apparent from the above, signals detected by the photodiodes 12 and 14 are respectively amplified by the amplifiers 103 and 106 and the difference between both amplified signals is then acquired by the differential amplifier 109, thus allowing only a probe signal to be detected.

The current that is monitored by the current monitor 107 is subjected to A/D conversion by the A/D converter 108 and the value of the resultant signal is used together with the value of the probe signal acquired by conversion in the A/D converter 111 in verifying the operations of the photodiodes 12 and 14, calibration and so forth. Further, it is necessary to match the polarization plane of the incident laser beam with the crystal axis of the electrooptic element 2. The polarization plane is adjusted by turning the ½ wavelength plate 4 and the ¼ wavelength plate 5.

According to such a conventional probe signal outputting apparatus, however, the probe body 15, the photodiodes 12 and 14 each of which converts the laser beam output from this probe body 15 to an optical current, and a current drive circuit, which supplies a drive current to the laser diode 9 in the probe body 15 based on a change in the monitored output of the optical current, are normally connected in a separable manner by connectors (not shown) or the like. This may produce transmission losses at the connected portions or may produce an input/output error in the optical current and drive current due to the unbalance of the electric resistances (contact resistances) at the connected portions, in which case a probe signal with a high probing precision cannot be sent to the measuring unit.

### SUMMARY OF THE INVENTION

Accordingly, it is an object of the present invention to provide a probe signal outputting apparatus which allows an electrooptic probe serving as a probe body, and a light receiving section having a current drive circuit and photodiodes to be handled as electrooptically coupled in an inseparable manner, thereby sufficiently preventing the loss of a low-level optical signal and a to-be-probed signal as signals to be handled and the occurrence of unbalance of contact resistances, and which is easy to handle and use.

According to this invention, the above object is achieved by a probe signal outputting apparatus comprising an electrooptic probe for receiving an optical output from a light source and outputting a first optical signal and a second optical signal which are polarized in accordance with a voltage of a to-be-probed signal from an object to-be-probed; a first photoelectric converting element and a second photoelectric converting element, connected in series between a first bias power supply and a second bias power supply, for respectively receiving the first optical signal and the second optical signal and converting the first and second optical signals to electric signals; an output circuit for outputting an electric signal acquired at a connection node between the first photoelectric converting element and the second photoelectric converting element; a current drive circuit, provided in an optical input/output unit together with the first photoelectric converting element, the second photoelectric converting elements and the output circuit, for supplying a drive current to the light source upon reception of a control voltage according to changes in currents flowing in the first photoelectric converting element and the second photoelectric converting element; and a power-supply/probe-signal output unit connected to the optical input/output unit and having an amplifier for amplifying the electric signal acquired at the connection node and outputting that amplified electric signal to a probing circuit side and a power supply for supplying power to an electric circuit in the optical input/output unit, wherein the electrooptic probe and the optical input/output unit are connected by a cable and the optical input/output unit and the power-supply/probe-signal output unit are connected by a connector in a separable manner.

As apparent from the above, according to this invention, the electrooptic probe is connected to the optical input/output unit by a cable, and the optical input/output unit is connected to the power-supply/probe-signal output unit in a separable manner by a connector, thus making it possible to prevent the loss of a low-level optical signal and a to-be-probed signal as signals to be handled and the occurrence of unbalance of contact resistances and to facilitate the handling and use of the probe signal outputting apparatus.

Further, according to this invention, the power-supply/probe-signal output unit is provided with amplifiers for plural channels, each of which amplifies the electric signal acquired at the connection node and outputs that amplified electric signal. This can allow plural sets of electrooptic probes with different performances to be connected to the optical input/output unit and the power-supply/probe-signal output unit according to the usage, thus providing such an advantage that use-dependent measuring operation can be switched quickly.

Furthermore, as the electrooptic probe is connectable to different optical input/output units which are designed for different usages, the electrooptic probe and optical input/output unit can be detachably connected to the power-supply/probe-signal output unit as an integrated unit which is designed differently for different usages. This provides such an advantage that the probe signal outputting apparatus becomes easy to use and handle.

### BRIEF DESCRIPTION OF THE DRAWINGS

FIG. 1 is a block diagram showing a probe signal outputting apparatus according to one embodiment of this invention;

FIG. 2 is a structural diagram conceptually illustrating an ordinary electrooptic probe in a probe signal outputting apparatus; and

FIG. 3 is a block diagram showing an ordinary light receiving circuit in a probe signal outputting apparatus.

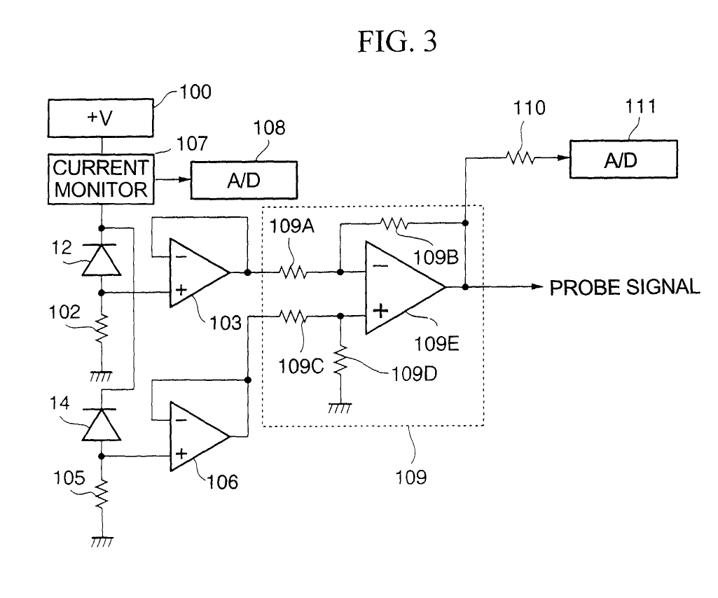

### DETAILED DESCRIPTION OF THE PREFERRED EMBODIMENT

An embodiment which will be discussed below in no way limits the present invention to the scope of the appended claims. Not all the features that will be described in the following description of the embodiment need to be combined in order to achieve the aforementioned object.

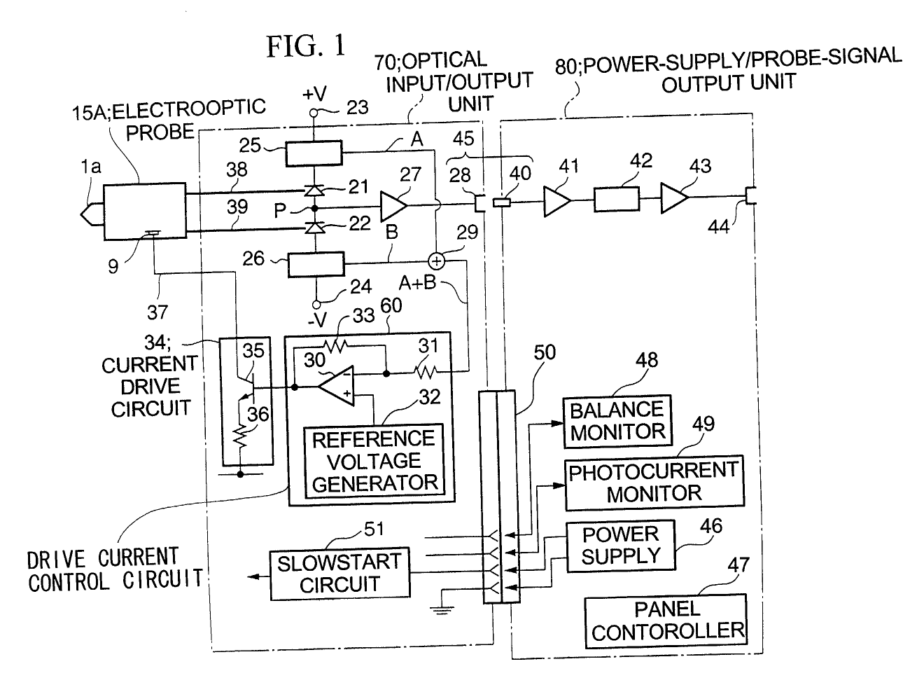

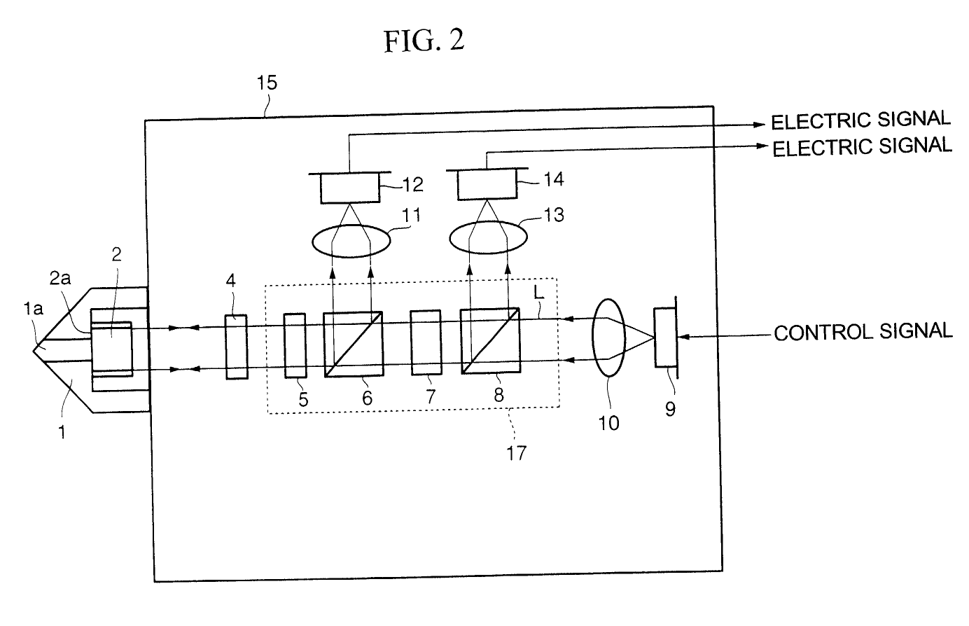

One embodiment of this invention will now be described with reference to the accompanying drawings. In FIG. 1, numeral “15A” is an electrooptic probe, which is designed as the electrooptic probe 15 shown in FIG. 2 from which the photodiodes 12 and 14 are removed. Reference symbol “70” is an optical input/output unit in which photodiodes 21 and 22 are connected in series. The series circuit of those photodiodes 21 and 22 are connected between a positive bias power supply 23 serving as a first bias power supply and a negative bias power supply 24 serving as a second bias power supply via current monitors 25 and 26 respectively. A signal output terminal 28 is connected to a connection node P between the photodiodes 21 and 22 via an (first) amplifier 27.

The current monitors 25 and 26 respectively monitor and convert the currents that flow in the photodiodes 21 and 22 to voltages. Individual monitored values A and B are input to an adder 29 which performs the operation A+B. A change in the sum of the currents to be monitored corresponds to a change in the amount of light emission from a laser diode 9. The operation output of the adder 29 is input to the negative input terminal of an operational amplifier 30 via a resistor 31. An arbitrary reference voltage (control voltage) output from a reference voltage generator 32 which constitutes a drive-current control circuit 60 is input to the positive input terminal of the operational amplifier 30. Therefore, the operational amplifier 30 outputs a control signal corresponding to the difference between the operation output of the adder 29 and the reference voltage from the reference voltage generator 32. A resistor 33, which is connected between the output terminal and the negative input terminal of the operational amplifier 30, determines an amplification factor together with the resistor 31. The operational amplifier 30 and the reference voltage generator 32, together with the resistors 31 and 33, constitute the drive-current control circuit 60.

A current drive circuit 34 is connected to the output side of the operational amplifier 30. This current drive circuit 34 is comprised of a current setting resistor 36 connected to the emitter of a transistor 35. This current drive circuit 34 supplies a drive current to the laser diode 9 serving as a light source in the electrooptic probe 15A via a coaxial cord serving as a cable upon reception of the control signal from the operational amplifier 30 at the base of the transistor 35, i.e., upon reception of the control signal according to changes in the monitored outputs of the current monitors 25 and 26. Note that the current drive circuit 34 outputs the drive current that causes the laser diode 9 to emit either pulsed light or continuous light.

Although not illustrated, the amount of deterioration of the S/N ratio can be detected indirectly by inputting the monitored values (voltage values) of the currents flowing through the photodiodes 21 and 22 to a subtracter as needed and detecting the amount of deviation in the optical balance from the voltage difference obtained as the subtraction result. Therefore, the deviation in the optical balance can be suppressed by adjusting the polarization ratio of the optical signals received by the photodiodes 21 and 22 in such a way as to correct this deterioration amount or in the direction of suppressing the deterioration amount.

Attached between the electrooptic probe 15A and the optical input/output unit 70 are optical fiber cables 38 and 39 which lead the emitted laser beams to the photodiodes 21 and 22 via polarization beam splitters 6 and 8 and converging lenses 11 and 13 as shown in FIG. 2.

Reference symbol “80” denotes a power-supply/probe-signal output unit that has, inside, a signal input terminal 40 connected to the signal output terminal 28 of the optical input/output unit 70, an amplifier 41 at a preceding stage, which amplifies the probe signal received through the signal input terminal 40, a filter 42 for removing a signal of a predetermined frequency from the probe signal, an amplifier 43 at a subsequent stage and a probe-signal output terminal 44. The signal output terminal 28 and the signal input terminal 40 are designed as a coaxial connector 45 for high-frequency transmission.

The power-supply/probe-signal output unit 80 is provided with a power supply 46 for supplying power to the electric circuits in the optical input/output unit 70, a panel controller 47, a balance monitor 48 for monitoring the amount of deviation in the optical balance or the difference between the optical currents from the photodiodes 21 and 22, and a photocurrent monitor 49 which monitors the amount of light from the laser diode 9 in terms of a value corresponding to the sum of the output currents of the photodiodes 21 and 22. The supply voltage, the balance monitor signal and the photocurrent monitor signal are exchangeable between the optical input/output unit 70 and the power-supply/probe-signal output unit 80 via individual input/output contacts that constitute a multielectrode connector 50. A slow-start circuit 51 which slows the rising of the supply voltage is connected to the power supply circuit of the optical input/output unit 70 to prevent circuit elements from being damaged by an excess current.

The operation of this apparatus will be discussed below. After power is supplied to the individual electric circuits from the power supply 46, a metal pin 1a of the electrooptic probe 15A brought into contact a probe point, so that, as mentioned earlier, an electric field generated in the metal pin 1a propagates to an electrooptic element 2 as shown in FIG. 2. The laser beam from the laser diode 9 reaches the electrooptic element 2 and is reflected at the end face thereof. The reflected laser beam contains a polarized component according to the voltage of a to-be-probed signal, passes through a ½ wavelength plate 4 and a ¼ wavelength plate 5, and is separated by the polarization beam splitters 6 and 8.

The separated individual laser beams leave the electrooptic probe 15A and enter the photodiodes 21 and 22 in the optical input/output unit 70 via the respective optical fiber cables 38 and 39 and are converted to electric signals according to the intensities of the laser beams. The optical currents that are produced in the photodiodes 21 and 22 appear at the connection node P and are output to a measuring unit, such as an oscilloscope or spectrum analyzer, via the amplifier 27, the coaxial connector 45, the amplifier 41, the filter 42, the amplifier 43, and the probe-signal output terminal 44.

When the output of the laser diode 9 varies, the currents flowing in the photodiodes 21 and 22 change even if the to-be-probed signal is kept at a constant state. Accordingly, the added value of the voltages acquired via the current monitors 25 and 26 also changes. This added value is compared with the value of the reference voltage from the reference voltage generator 32 in the operational amplifier 30. In accordance with the comparison result, a control signal which stabilizes the light from the laser diode 9 is input to the current drive circuit 34. It is therefore possible to stabilize the optical output of the laser diode 9 irrespective of changes in the currents flowing in the photodiodes 21 and 22, so that the sensitivity of detection of the to-be-probed signal can be kept constant.

As the probe signal outputting apparatus receives two optical signals which have deflection characteristics according to the voltage of the to-be-probed signal and adjusts the output light of the laser diode 9 in accordance with changes in those signals, it is possible to prevent the changes from appearing as an error in the probe signal and convert the received optical signals to electric signals accurately. This can contribute to improving the measuring precision of the measuring unit.

According to this invention, because the levels of the optical signals and electric signals that are handled between the electrooptic probe 15A and the optical input/output unit 70 are relatively low and vary delicately, those optical signals and electric signals are exchanged between the electrooptic probe 15A and the optical input/output unit 70 by using the optical fiber cables 38 and 39 and the coaxial cable 37 which are connected in a fixed manner between the electrooptic probe 15A and the optical input/output unit 70 without using a connector. This design can reliably prevent the loss of the optical signals and electric signals and the leakage thereof outside. Shortening the optical fiber cables 38 and 39 and the coaxial cable 37 can further reduce the signal loss, thus further improving the sensitivity of detection of the to-be-probed signal.

Different electrooptic probes 15A are used for different usages. In this case, the electrooptic probe 15A is assembled and treated as integral with the optical input/output unit 70. The optical input/output unit 70 and the power-supply/probe-signal output unit 80 are connected together in a separable manner by the coaxial connector 45 for outputting the probe signal and the multielectrode connector 50 for inputting and outputting the supply voltage, the balance monitor signal and the photocurrent monitor signal, and the attachment and detachment of the optical input/output unit 70 and the power-supply/probe-signal output unit 80 can be carried out as desired. In accordance with the usage, therefore, the electrooptic probe 15A is replaced with an adequate one which in turn is connected together with the optical input/output unit 70 to the power-supply/probe-signal output unit 80. In the case where the power-supply/probe-signal output unit 80 is provided with a plurality of probe-signal transmission systems for plural channels, the electrooptic probe 15A is also connected together with the optical input/output unit 70 to the amplifiers 41 and 43 and the filter 42 for any one of the channels via a predetermined coaxial connector 45.

There are two types of electrooptic probes 15A: a standard type which has, for example, a sensitivity of 1 and a frequency characteristic of 10 MHz to 1 GHz and a high-sensitivity type which has a sensitivity of 3 and a frequency characteristic of 50 MHz to 1 GHz. Optical input/output units which have performances and functions according to those types are integrally connected to the respective types of electrooptic probes.

Instead of abutting the metal pin 1a to the electrooptic element 2 of the probe head 1, a socket which supports the metal pin 1a in an attachable/detachable (exchangeable) manner may be made to contact the electrooptic element 2. This modification can ensure quick and easy replacement of the metal pin 1a alone.

According to this invention, as described above, the electrooptic probe is connected to the optical input/output unit by a cable, and the optical input/output unit is connected to the power-supply/probe-signal output unit in a separable manner by a connector, thus making it possible to prevent the loss of a low-level optical signal and a to-be-probed signal as signals to be handled and the occurrence of unbalance of contact resistances and to facilitate the handling and use of the probe signal outputting apparatus.

Further, according to this invention, the power-supply/probe-signal output unit is provided with amplifiers for plural channels, each of which amplifies the electric signal acquired at the connection node and outputs that amplified electric signal. This can allow plural sets of electrooptic probes with different performances to be connected to the optical input/output unit and the power-supply/probe-signal output unit according to the usage, thus providing such an advantage that use-dependent measuring operation can be switched quickly. Furthermore, as the electrooptic probe is connectable to different optical input/output units which are designed for different usages, the electrooptic probe and optical input/output unit can be detachably connected to the power-supply/probe-signal output unit as an integrated unit which is designed differently for a different usage. This facilitates the use and handling of the probe signal outputting apparatus.

What is claimed is:

1. A probe signal outputting apparatus comprising:
an electrooptic probe for receiving an optical output from a light source and outputting a first optical signal and a second optical signal which are polarized in accordance with a voltage of a to-be-probed signal from an object to-be-probed;
a first photoelectric converting element and a second photoelectric converting element, connected in series between a first bias power supply and a second bias power supply, for respectively receiving said first optical signal and said second optical signal and converting said first and second optical signals to electric signals;
an output circuit for outputting an electric signal acquired at a connection node between said first photoelectric converting element and said second photoelectric converting element;
a current drive circuit, provided in an optical input/output unit together with said first photoelectric converting element, said second photoelectric converting elements and said output circuit, for supplying a drive current to said light source upon reception of a control voltage according to changes in currents flowing in said first photoelectric converting element and said second photoelectric converting element; and
a power-supply/probe-signal output unit connected to said optical input/output unit and having an amplifier for amplifying said electric signal acquired at said connection node and outputting that amplified electric signal to a probing circuit side and a power supply for supplying power into an electric circuit in said optical input/output unit,
wherein said electrooptic probe and said optical input/output unit are connected by a cable and said optical input/output unit and said power-supply/probe-signal output unit are connected by a connector in a separable manner.

2. The probe signal outputting apparatus according to claim 1, wherein said power-supply/probe-signal output unit has amplifiers for plural channels for each amplifying said electric signal acquired at said connection node and outputting that amplified electric signal.

3. The probe signal outputting apparatus according to claim 1, wherein said electrooptic probe is connectable to different optical input/output units which are designed for different usages.
